(19) United States
(12) Patent Application Publication
(10) Pub. No.: US 2021/0363065 A1
(43) Pub. Date: Nov. 25, 2021

(54) LITHIUM-GARNET COMPOSITE CERAMIC ELECTROLYTE

(71) Applicants: Corning Incorporated, Corning, NY (US); Shanghai Institute of Ceramics, Chinese Academy of Sciences, Shanghai (CN)

(72) Inventors: Michael Edward Badding, Campbell, NY (US); Jun Jin, Shanghai (CN); Zhen Song, Painted Post, NY (US); Jianmeng Su, Shanghai (CN); Zhaoyin Wen, Shanghai (CN); Tongping Xiu, Shanghai (CN); Chujun Zheng, Huizhou City (CN)

(21) Appl. No.: 17/236,528

(22) Filed: Apr. 21, 2021

(30) Foreign Application Priority Data
Apr. 23, 2020 (CN) 202010327279.X

(51) Int. Cl. C04B 35/48; H01M 10/0525; H01M 10/0562

(52) U.S. Cl. CPC C04B 35/48; H01M 10/0525; H01M 2300/0077; C04B 2235/764; C04B 2235/3203; H01M 10/0562

(57) ABSTRACT

A sintered composite ceramic, including: a lithium-garnet major phase; and a lithium-rich minor phase, such that the lithium-rich minor phase comprises LiₓZrO_{(x+4)/2}, with 2≤x≤10.

### BACKGROUND

This application claims the benefit of priority under 35 U.S.C. § 119 of Chinese Patent Application Serial No. 202010327279.X, filed on Apr. 23, 2020, the content of which is relied upon and incorporated herein by reference in its entirety.

### 1. Field

This disclosure relates to lithium-garnet composite ceramic electrolytes with improved critical current density (CCD).

### 2. Technical

Conventional lithium (Li)-ion batteries have been widely studied but still suffer from limited capacity density, energy density, and safety concerns, posing a challenge for large-scale application in electrical equipment. For example, while solid-state lithium batteries based on Li-garnet electrolyte (LLZO) address the safety concerns, insufficient contact between the Li anode and garnet electrolyte due to the rigid ceramic nature and poor lithium wettability of garnet, as well as surface impurities, often lead to large polarization and large interfacial resistances, thereby causing inhomogeneous deposition of lithium and lithium dendrites formation.

Thus, as a result of poor contact between the Li anode and garnet electrolyte, the battery may experience a low critical current density (CCD) and eventual short circuiting.

The present application discloses improved lithium-garnet composite ceramic electrolytes for enhanced Li anode/garnet electrolyte interfaces in solid-state lithium metal battery applications.

### SUMMARY

In some embodiments, a sintered composite ceramic, comprises: a lithium-garnet major phase; and a lithium-rich minor phase, wherein the lithium-rich minor phase comprises LiₓZrO_{(x+4)/2}, with 2≤x≤10.

In one aspect, which is combinable with any of the other aspects or embodiments, the lithium-garnet major phase comprises at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi or Y and 0<b<1; (iii) Li_{7-c}La₃(Zr_{2-c},N_{c})O₁₂, with N=In, Si, Ge, Sn, V, W, Te, Nb, or Ta and 0<c<1, or a combination thereof.

In one aspect, which is combinable with any of the other aspects or embodiments, a mass ratio of lithium-garnet major phase to lithium-rich minor phase is in a range of 100:1 to 100:12.

In one aspect, which is combinable with any of the other aspects or embodiments, a ratio of lithium-to-zirconium in the lithium-rich minor phase is in a range of 4 to 5.

In one aspect, which is combinable with any of the other aspects or embodiments, the ceramic has a relative density of at least 90% of a theoretical maximum density of the ceramic.

In one aspect, which is combinable with any of the other aspects or embodiments, the ceramic has an ionic conductivity of at least 0.6 mS·cm⁻¹.

In one aspect, which is combinable with any of the other aspects or embodiments, the ceramic has a critical current density (CCD) of at least 1.0 mA·cm⁻².

In one aspect, which is combinable with any of the other aspects or embodiments, the ceramic has a critical current density (CCD) of at least 1.4 mA·cm⁻².

In some embodiments, a sintered composite ceramic, comprises: a lithium-garnet major phase; and a lithium-rich minor phase, wherein the lithium-rich minor phase comprises at least one of: Li₆Zr₂O₇, Li₈ZrO₆, or a combination thereof.

In one aspect, which is combinable with any of the other aspects or embodiments, the lithium-garnet major phase comprises at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi or Y and 0<b<1; (iii) Li_{7-c}La₃(Zr_{2-c},N_{c})O₁₂, with N=In, Si, Ge, Sn, V, W, Te, Nb, or Ta and 0<c<1, or a combination thereof.

In one aspect, which is combinable with any of the other aspects or embodiments, a mass ratio of lithium-garnet major phase to lithium-rich minor phase is in a range of 100:1 to 100:12.

In one aspect, which is combinable with any of the other aspects or embodiments, a ratio of lithium-to-zirconium in the lithium-rich minor phase is in a range of 4 to 5.

In one aspect, which is combinable with any of the other aspects or embodiments, the lithium-rich minor phase comprises one of: (i) Li₆Zr₂O₇; or (ii) Li₆Zr₂O₇ and Li₈ZrO₆.

In some embodiments, a battery, comprises: at least one lithium electrode; and an electrolyte in contact with the at least one lithium electrode, wherein the electrolyte is a lithium-garnet composite electrolyte comprising the sintered composite ceramic as disclosed herein.

In some embodiments, a method of making the composite ceramic as disclosed herein, comprises: a first mixing of inorganic source materials to form a mixture, including a lithium source compound and and at least one transition metal compound; a first milling of the mixture to reduce the particle size of the precursors; calcining the milled mixture to form a garnet oxide at from 800 to 1200° C.; a second mixing of the milled and calcined garnet oxide with at least one minor phase additive to form a second mixture; a second milling of the second mixture to reduce the particle size of constituents of the second mixture; compacting the second milled second mixture into a green pellet; and sintering the green pellet at a temperature ranging from 1000° C. to 1300° C.

In one aspect, which is combinable with any of the other aspects or embodiments, at least one of the lithium source compound or the minor phase additive is present in a stoichiometric excess.

In one aspect, which is combinable with any of the other aspects or embodiments, the minor phase additive comprises LiₓZrO_{(x+4)/2}, with 2≤x≤10.

In one aspect, which is combinable with any of the other aspects or embodiments, the minor phase additive comprises at least one of: Li₆Zr₂O₇, Li₈ZrO₆, or a combination thereof.

In one aspect, which is combinable with any of the other aspects or embodiments, a mass ratio of the milled and calcined garnet oxide to the at least one minor phase additive is in a range of 100:1 to 100:12.

In one aspect, which is combinable with any of the other aspects or embodiments, a ratio of lithium-to-zirconium in the at least one minor phase additive is in a range of 4 to 5.

### BRIEF DESCRIPTION OF THE DRAWINGS

The disclosure will become more fully understood from the following detailed description, taken in conjunction with the accompanying figures, in which:

FIG. 1 illustrates an x-ray diffraction (XRD) of lithium-rich additives with different lithium-to-zirconium (Li:Zr) molar ratios, according to some embodiments.

FIG. 2 illustrates an XRD pattern of LLZO-LZO with additives LZO-4 (Sample 2) and LZO-4.5 (Sample 7), according to some embodiments.

FIG. 3 illustrates a cross-sectional scanning electron microscopy (SEM) image of Comparative Sample 1, according to some embodiments.

FIG. 4 illustrates an SEM image of Sample 7, according to some embodiments.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments. It should be understood that the present application is not limited to the details or methodology set forth in the description or illustrated in the figures. It should also be understood that the terminology is for the purpose of description only and should not be regarded as limiting.

Additionally, any examples set forth in this specification are illustrative, but not limiting, and merely set forth some of the many possible embodiments of the claimed invention. Other suitable modifications and adaptations of the variety of conditions and parameters normally encountered in the field, and which would be apparent to those skilled in the art, are within the spirit and scope of the disclosure.

### Definitions

“Major phase,” “first phase,” or like terms or phrases refer to a physical presence of a lithium garnet in greater than 50% by weight, by volume, by mols, or like measures in the composition.

“Minor phase,” “second phase,” or like terms or phrases refer to a physical presence of a lithium dendrite growth inhibitor (i.e., grain boundary bonding enhancer) in less than 50% by weight, by volume, by mols, or like measures in the composition.

“SA,” “second additive,” “second phase additive,” “second phase additive oxide,” “phase additive oxide,” “additive oxide,” “additive,” or like terms refer to an additive oxide that produces a minor phase or second minor phase within the major phase when included in the disclosed compositions.

“LLZO” or like terms refer to compounds comprising lithium, lanthanum, zirconium, and oxygen elements. For example, lithium-garnet electrolyte comprises at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi or Y and 0<b<1; (iii) Li_{7-c}La₃(Zr_{2-c},N_{c})O₁₂, with N=In, Si, Ge, Sn, V, W, Te, Nb, or Ta and 0<c<1, or a combination thereof.

“Include,” “includes,” or like terms means encompassing but not limited to, that is, inclusive and not exclusive.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

For example, in modifying the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, “about” or similar terms refer to variations in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” (or similar terms) also encompasses amounts that differ due to aging of a composition or formulation with a particular initial concentration or mixture and amounts that differ due to mixing or processing a composition or formulation with a particular initial concentration or mixture.

As utilized herein, “optional,” “optionally,” or the like are intended to mean that the subsequently described event or circumstance can or cannot occur, and that the description includes instances where the event or circumstance occurs and instances where it does not occur. The indefinite article “a” or “an” and its corresponding definite article “the” as used herein means at least one, or one or more, unless specified otherwise.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The compositions, articles, and methods of the disclosure can include any value or any combination of the values, specific values, more specific values, and preferred values described herein, including explicit or implicit intermediate values and ranges.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

As explained above, solid-state lithium batteries based on Li-garnet electrolyte (LLZO) often suffer from insufficient contact between the Li anode and garnet electrolyte, which often leads to the battery experiencing a low critical current density (CCD) and eventual short circuiting. Conventional approaches to address these issues have included: (A) H₃PO₄ acid treatments for removing impurities while forming a protective interlayer of Li₃PO₄ to increase CCD of the electrolyte to 0.8 mA·cm⁻² and (B) modifying the electrolyte-anode interface with SnO₂ and MoS₂ to form Sn, Mo, and related alloy interlayers. However, it was found that for these proposals, as the battery circulates, the interlayers gradually become exhausted and result in eventual battery failure. Moreover, these interlayers do not increase the resistance of the electrolyte itself against lithium dendrite growth.

Composite ceramic electrolytes are effective in improving bonding at the major phase grain boundary, thereby improving CCD by minimizing lithium dendrite growth. Critical current density (CCD) refers to the maximum current density that LLZO electrolyte can tolerate before lithium dendrite penetration occurs in the electrolyte, which affects the dendrite suppression capability of the electrolyte. By adding additives during the LLZO sintering process, the additive or its decomposition product aggregates at the grain boundary to enhance grain boundary bonding and block lithium dendrite growth. Current efforts at studying additives have included (i) LiOH.H₂O in LLZO to form a minor phase of Li₂CO₃ and LiOH or (ii) adding Li₃PO₄ to LLZO precursor and allowing Li₃PO₄ to remain as the minor phase at the grain boundaries by controlling sintering conditions or (iii) adding LiAlO₂-coated LLZO particles to obtain a Li-garnet composite ceramic electrolyte. However, none of (i) to (iii), can achieve a desired CCD to meet the requirements of practical applications.

Disclosed herein is a Li-garnet composite ceramic electrolyte prepared by adding a lithium-rich additive (e.g., LiₓZrO_{(x+4)/2} (2≤x≤10), “LZO”), into LLZO with optional elemental doping (e.g., at least one of In, Si, Ge, Sn, V, W, Te, Nb, Ta, Al, Ga, Fe, Bi, Y, etc.), during LLZO ceramic sintering, according to some embodiments. In some embodiments, while variations of LZO include Li₂ZrO₃, Li₆Zr₂O₇, and Li₈ZrO₆, the sintering atmosphere is mainly Li₆Zr₂O₇ and Li₈ZrO₆. Li₂ZrO₃ as a second phase may gather at the LLZO grain boundary. Elemental dopants may be used to stabilize LLZO into a cubic phase with at least one of In, Si, Ge, Sn, V, W, Te, Nb, Ta, Al, Ga, Fe, Bi, Y, etc.

The composite ceramic comprises a major LLZO phase and a minor LZO second phase. The addition of lithium-rich additive during sintering reduces sintering temperature of LLZO and creates a lithium atmosphere for LLZO sintering, which simplifies the sintering process and reduces its cost. The lithium-rich additives and their decomposition products are distributed at the LLZO grain boundary, which enhances bonding at the LLZO grain boundary and blocks formation of lithium dendrite growth. The CCD of the Li-garnet composite described herein is at least 1.4 mA·cm⁻².

Methods for Preparation of Li-Garnet Composite Ceramic Electrolyte

First Mixing Step

In the first mixing step, a stoichiometric amount of inorganic materials is mixed together, in the formula of garnet oxides and, for example, milled into fine powder. The inorganic materials can be, for example, a lithium compound and at least one transition metal compound (e.g., La-based, Zr-based, etc.). In some embodiments, the inorganic materials compounds may also comprise at least one of Al, Ga, Fe, Bi, Y, In, Si, Ge, Sn, V, W, Te, Nb, Ta, Mg, or combinations thereof in the chemical formula.

In some embodiments, it may be desirable to include an excess of a lithium source material in the starting inorganic batch materials to compensate for the loss of lithium during the high temperature of from 1000° C. to 1300° C. (e.g., 1100° C. to 1200° C.) sintering step. The first mixing step can be a dry milling process, or a wet milling process with an appropriate liquid that does not dissolve the inorganic materials. The mixing time, such as from several minutes to several hours, can be adjusted, for example, according to the scale or extent of the observed mixing performance (e.g., 1 min to 48 hrs, or 30 mins to 36 hrs, or 1 hr to 24 hrs (e.g., 12 hrs), or any value or range disclosed therein). The milling can be achieved by, for example, a planetary mill, an attritor, or like mixing or milling apparatus.

Calcining Step

In the calcining step, the mixture of inorganic material, after the first mixing step, is calcined at a predetermined temperature, for example, at from 800° C. to 1200° C. (e.g., 950° C.), including intermediate values and ranges, to react and form the target Li-garnet. The predetermined temperature depends on the type of the Li-garnet. The calcination time, for example, varies from 1 hr to 48 hrs (e.g., 2 hrs to 36 hrs, or 3 hrs to 24 hrs, or 4 hrs to 12 hrs (e.g., 6 hrs), or any value or range disclosed therein), and also may depend upon on the relative reaction rates of the selected inorganic starting or source batch materials. In some embodiments, a pre-mix of inorganic batch materials can be milled and then calcinated or calcined, as needed, in a first step.

Second Mixing Step

The calcined Li-garnet mixture and minor or second phase additives are mixed together and ground to form a mixture of a homogeneous composition (e.g., as determined by the LZO distribution in green ceramic pellets or bars). LZO minor phase was prepared in similar manner as described in the First Mixing (milling for 30 mins to 36 hrs, e.g., 24 hrs) and Calcining (e.g., for 12 hrs to 24 hrs) steps. The second mixing step can include, for example, one or more of: a wet-milling, a dry-milling, or a combination thereof. During milling of the mixture, one can optionally heat the mixture at a low temperature of, for example, from 60° C. to 100° C. (e.g., 70° C.) to remove adsorbed moisture or solvents.

Compacting Step

The homogeneous second mixture composition was pulverized simultaneously during the second mixing step. After drying at temperatures ranging from 60° C. to 100° C. (e.g., 70° C.) for a time ranging from 6 hrs to 24 hrs (e.g., 12 hrs), the second mixture composition was compacted by passing through a 200-grit sieve to form a green pellet. The green pellet may be formed as arbitrary shapes by any suitable method, for example, cold isotropic pressing, hot isotropic pressing, hot pressing, uniaxial pressing, or by like means and instrumentalities. The green pellet may have at least one dimension ranging from 1 mm to 30 mm (e.g., ˜20 mm). The green pellet is then sintered at a temperature greater than the temperature of the calcining step, as described below.

Sintering Step

During the sintering step, the green pellet was placed in a crucible with a lid (e.g., Pt, ZrO₂, Al₂O₃ and MgO crucible). The sintering temperature was, for example, from 1000 to 1300° C., including intermediate values and ranges, with a temperature ramping rate (pre-sintering) and cooling rate (post-sintering) ranging from 0.5° C./min to 10° C./min (e.g., 5° C./min).

### EXAMPLES

### Example 1—Li-Garnet (LLZO) Electrolyte Preparation

Precursor powder LiOH.H₂O (AR, 2% excess), La₂O₃ (99.99%, calcined at 900° C. for 12 hours), ZrO₂ (AR), and Ta₂O₅ (99.99%) were weighed and mixed according to the stoichiometric ratio of Li_{6.5}La₃Zr_{1.5}Ta_{0.5}O₁₂. Wet ball milling was conducted for 12 hours via yttrium-stabilized zirconia (YSZ) balls as the grinding medium at a speed of 250 rpm using isopropanol as the solvent. The dried mixture power was calcined in an alumina crucible at 950° C. for 6 hours to obtain pure cubic Li-garnet electrolyte powder.

In some embodiments, the solid electrolyte is a Li-garnet ceramic electrolyte LLZO with a chemical formula of one or more of Li_{7.3a}La₃Zr₂LₐO₁₂ (L=Al, Ga or Fe; 0<a<0.33), Li₇La_{3-b}Zr₂M_{b}O₁₂ (M=Bi or Y; 0<b<1), and Li_{7-c}La₃(Zr_{2-c},N_{c})O₁₂ (N=In, Si, Ge, Sn, V, W, Te, Nb, Ta; 0<c<1).

### Example 2—Lithium-Rich Additive (LZO) Preparation

The precursor powder LiOH.H₂O (AR) and ZrO₂ (AR) were weighed at a molar ratio of x (2<x<10). Wet ball milling was conducted for 24 hours via yttrium-stabilized zirconia (YSZ) beads as the grinding medium at a speed of 250 rpm using isopropanol as the solvent. The dried mixture power was calcined in an alumina crucible at 950° C. for 12-24 hours.

### Example 3—Preparation of Li-Garnet Composite Ceramic Electrolyte (LLZO-LZO)

The LLZO powder of Example 1 and LZO powder of Example 2 were weighed in a predetermined ratio and wet-milled at 250 rpm for 12 hours using the same techniques described above. The obtained mixture was dried at 70° C. for 12 hours and then passed through a 200-grit sieve. A green pellet (1.25 grams) with a diameter of 18 mm was formed by uniaxial pressing at a pressure of 140 MPa. Thereafter, the green body was placed in an Al₂O₃, MgO or Pt crucible and sintered at 1190° C. for 30 minutes to obtain LLZO-LZO. Temperature ramping rate and cooling rate pre- and post-sintering, respectively, was conducted at 5° C./min. The mother powder was not used in the sintering process in this experiment.

Optionally, mother powder (Li_{6.5}La₃Zr_{1.5}Nb_{0.5}O₁₂) may also be used to compensate Li-garnet (LLZO) electrolyte samples' lithium loss during sintering. The synthesis process for the mother powder is similar to that for preparing LLZO as described herein (e.g., Example 1), except with excessive lithium content in the precursor powder (e.g., 15%). While sintering to prepare LLZO-LZO composite, the green pellet may optionally be covered by a mother powder to prevent loss of volatile components (Li₂O) and avoid the presence of a lithium-deficient phase (La₂Zr₂O₇). At the same time, the presence of a Li₂O atmosphere promotes densification of LLZO.

### Example 4—Preparation of Coin Cell

LLZO-LZO electrolyte pellets prepared in Example 3 were polished first with 400-grit and second with 1200-grit SiC sandpaper, followed by Au-sputtering thereon for 5 minutes. After transferring to an argon-filled glove box, the cell was assembled by positioning lithium metal foil at a center portion of a first LLZO-LZO sample surface and heating it to 250-300° C. on a hot plate. Because of the heating, molten lithium spread across the first surface of the pellet. Thereafter, the sample was rotated, followed by the same lithium metal positioning and heating steps to a second LLZO-LZO sample surface. The Li/LLZO-LZO/Li symmetrical battery was finally sealed in a CR2032 coin cell.

### Example 5—Characterization Techniques

Morphology and Phase Analysis

Scanning electron microscopy (SEM) images were obtained by a scanning electron microscope (Hitachi, S-3400N). Element mapping images were characterized by an energy dispersive spectrometer (EDS) affiliated with the HITACHI SEM. X-ray powder diffraction (XRD) patterns were obtained by x-ray powder diffraction (Rigaku, Ultima IV, nickel-filtered Cu-Kα radiation, λ=1.542 Å) in the 20 range of 10-80° at room temperature. Density of the ceramic samples was measured by the Archimedes method with ethanol as the immersion medium.

Electrochemical Impedance Spectroscopy (EIS)

EIS was measured by AC impedance analysis (Autolab, Model PGSTAT302 N) with a frequency range of 0.1 Hz to 1 MHz.

Electrochemical Performance

All Li symmetric cells and the full battery were tested on a LAND CT2001A battery test system (Wuhan, China). The Li/LLZO-LZO/Li symmetrical battery prepared in Example 4 was subjected to a rate cycling test at an initial current density of 0.1 mA·cm⁻², followed by increments of 0.1 mA·cm⁻² to determine the critical current density (CCD) of LLZO-LZO. Charge and discharge durations were set to 30 minutes. All battery tests were performed at 25° C.

### Example 6—Sample Preparation and Characterization

Sample 1

Precursor powder LiOH.H₂O (AR) and ZrO₂ (AR) were weighed at a LiOH.H₂O-to-ZrO₂ molar ratio of 4. Wet ball milling was conducted for 24 hours by using yttrium-stabilized zirconia (YSZ) beads as a grinding medium at a speed of 250 rpm using isopropanol as a solvent. The dried mixture powder was calcined in alumina crucible at 950° C. for 24 hours to obtain a lithium-rich additive powder (“LZO-4”).

Li-garnet electrolyte LLZO and the lithium-rich additive LZO-4 were ball milled at a mass ratio of 100:2 (40 g of LLZO-to-0.8 g of LZO-4, with 120 g isopropyl alcohol). The LLZO powder and LZO-4 powder were weighed at the 100:2 mass ratio and wet-milled at 250 rpm for 12 hours. Particle size distribution (D90) ranged between 1.2 μm and 1.7 μm. The obtained mixture was dried at 70° C. for 12 hours and then passed through a 200-grit sieve. A green pellet (1.25 grams) with a diameter of 18 mm was formed by uniaxial pressing at a pressure of 140 MPa. Thereafter, the green body was placed in a MgO crucible and sintered at 1190° C. for 30 minutes.

Sample 2

Preparation was the same as in Sample 1, except the Li-garnet electrolyte LLZO and lithium-rich additive LZO-4 were ball milled at a mass ratio of 100:4.

Sample 3

Preparation was the same as in Sample 1, except the Li-garnet electrolyte LLZO and lithium-rich additive LZO-4 were ball milled at a mass ratio of 100:8.

Sample 4

Preparation was the same as in Sample 1, except the Li-garnet electrolyte LLZO and lithium-rich additive LZO-4 were ball milled at a mass ratio of 100:12.

Sample 5

Precursor powder LiOH.H₂O (AR) and ZrO₂ (AR) were weighed at a LiOH.H₂O-to-ZrO₂ molar ratio of 4.5. Wet ball milling was conducted for 24 hours by using yttrium-stabilized zirconia (YSZ) beads as a grinding medium at a speed of 250 rpm using isopropanol as a solvent. The dried mixture powder was calcined in alumina crucible at 950° C. for 24 hours to obtain a lithium-rich additive powder (“LZO-4.5”).

Li-garnet electrolyte LLZO and the lithium-rich additive LZO-4.5 were ball milled at a mass ratio of 100:1 (40 g of LLZO-to-0.4 g of LZO-4.5, with 120 g isopropyl alcohol). The LLZO powder and LZO-4 powder were weighed at the 100:2 mass ratio and wet-milled at 250 rpm for 12 hours. Particle size distribution (D90) ranged between 1.2 μm and 1.7 μm. The obtained mixture was dried at 70° C. for 12 hours and then passed through a 200-grit sieve. A green pellet (1.25 grams) with a diameter of 18 mm was formed by uniaxial pressing at a pressure of 140 MPa. Thereafter, the green body was placed in a Pt crucible and sintered at 1190° C. for 30 minutes.

Sample 6

Preparation was the same as in Sample 5, except the Li-garnet electrolyte LLZO and lithium-rich additive LZO-4.5 were ball milled at a mass ratio of 100:2.

Sample 7

Preparation was the same as in Sample 5, except the Li-garnet electrolyte LLZO and lithium-rich additive LZO-4.5 were ball milled at a mass ratio of 100:4.

Sample 8

Preparation was the same as in Sample 5, except the Li-garnet electrolyte LLZO and lithium-rich additive LZO-4.5 were ball milled at a mass ratio of 100:8.

Comparative Sample 1

Preparation was the same as in Sample 1, except that no LZO was added into the LLZO garnet powder, and the green pellet was buried in 0.4 g mother powder (Li_{6.5}La₃Zr_{1.5}Nb_{0.5}O₁₂, lithium excess 15%) during during LLZO sintering.

Comparative Sample 2

Preparation was the same as in Sample 1, except that no LZO was added.

Table 1 shows selected preparation conditions and performance attributes for Samples 1-8 and Comparative Samples 1 and 2.

TABLE 1

| | | | | Relative | Ionic | |
|---|---|---|---|---|---|---|
| | Li:Zr Ratio | LLZO:LZO | | Density | Conductivity | CCD |
| Sample | in LZO | Mass Ratio | Crucible | (%) | (mS · cm⁻¹) | (mA · cm⁻²) |
| Comparative 1 | N/A | 0 | MgO | 93.6 | 0.687 | 0.4 |
| Comparative 2 | N/A | 0 | MgO | 76.99 | 0.0123 | — |
| 1 | 4 | 100:2 | MgO | 93.79 | 0.674 | 0.7 |
| 2 | 4 | 100:4 | MgO | 95.32 | 0.664 | 1.4 |
| 3 | 4 | 100:8 | MgO | 94.47 | 0.576 | 0.8 |
| 4 | 4 | 100:12 | MgO | 92.79 | 0.447 | 0.7 |
| 5 | 4.5 | 100:1 | Pt | 96.12 | 0.735 | 1.0 |
| 6 | 4.5 | 100:2 | Pt | 95.97 | 0.729 | 1.1 |
| 7 | 4.5 | 100:4 | Pt | 96.31 | 0.648 | 1.2 |
| 8 | 4.5 | 100:8 | Pt | 94.39 | 0.458 | 0.5 |

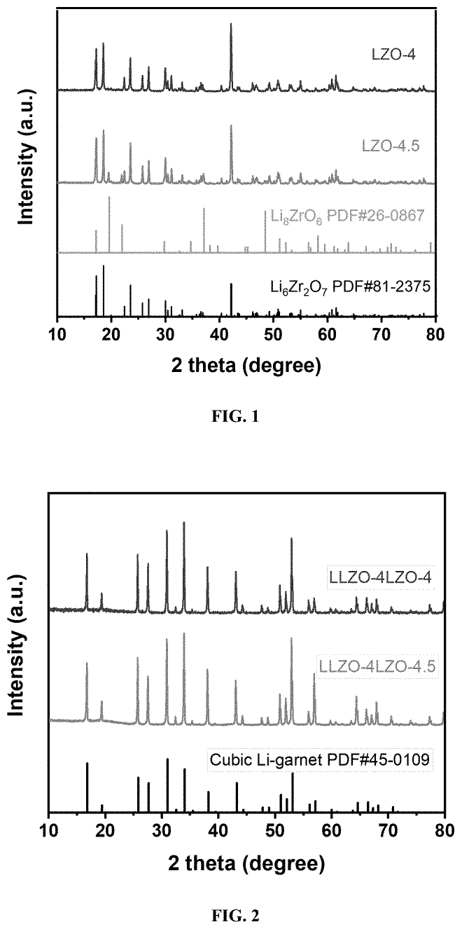

FIG. 1 illustrates an x-ray diffraction (XRD) of lithium-rich additives with different lithium-to-zirconium (Li:Zr) molar ratios, according to some embodiments. The XRD peaks of LZO-4 indicate a close match with the XRD fingerprints of the control PDF #81-2375 sample, confirming that the chemical structure of LZO-4 is Li₆Zr₂O₇ (i.e., when the precursor LiOH.H₂O and ZrO₂ were used such that the molar ratio of lithium-to-zirconium equals 4—as used in Samples 1-4).

When the molar ratio of lithium-to-zirconium is raised to 4.5 (as used in Samples 5-8), excess Li₂O will react with Li₆Zr₂O₇ to form Li₈ZrO₆, which results in LZO-4.5 as a two-phase system, including the main phase Li₆Zr₂O₇ and the secondary phase Li₈ZrO₆ (PDF #26-0867). FIG. 1 illustrates that the phase composition of LZO is affected by the molar ratio of lithium-to-zirconium. Li₆Zr₂O₇ and Li₈ZrO₆ with different composition ratios can be obtained by changing the lithium-to-zirconium ratio in the raw materials. So, for example, if the molar ratio of lithium-to-zirconium decreases (versus a lithium-to-zirconium molar ratio of 4), a two-phase system of Li₆Zr₂O₇ and Li₂ZrO₃ will appear).

FIG. 2 illustrates an XRD pattern of a Li-garnet composite ceramic electrolyte (LLZO-LZO) as in Sample 2, with an LZO-4 additive, and LLZO-LZO as in Sample 7, with an LZO-4.5 additive, according to some embodiments. Because the XRD peaks of both Samples 2 and 7 appear to be well-matched with cubic Li-garnet electrolyte control sample (PDF #45-0109), this indicates that addition of LZO does not affect the phase composition of LLZO. Pristine LLZO (e.g. Li₇La₃Zr₂O₁₂) has cubic (c-LLZO) and tetragonal (t-LLZO) phases at different temperature. The c-LLZO has a higher ionic conductivity than t-LLZO (c-LLZO at 10⁻³˜10⁻⁴ S/cm⁻¹ versus t-LLZO at 10⁻⁵˜10⁻⁶ S/cm⁻¹). The tetragonal phase is a room-temperature stable phase, and it is often necessary to introduce doped ions (e.g., at least one of In, Si, Ge, Sn, V, W, Te, Nb, Ta, Al, Ga, Fe, Bi, Y, etc.) to stabilize cubic phase at room temperature. According to the XRD results of FIG. 2, no t-LLZO phase was detected. Thus, the LLZO used here (e.g., Li_{6.5}La₃Zr_{1.5}Ta_{0.5}O₁₂) can be regarded as a single-phase material.

Table 1 above presents selected preparation conditions and performance attributes for Samples 1-8 and Comparative Samples 1 and 2. Comparative Sample 2, in which no mother powder was used and no LZO was added into Li-garnet powder, was not well-sintered, as indicated by the low relative density (as compared to a theoretical maximum density of the ceramic) (76.99%) in comparison with other samples which exceed 90%. Comparative Sample 1, in which mother powder was used but no LZO was added into Li-garnet powder, is able to achieve relative density values comparable to the average of Samples 1-8 (Comparative 1: 93.6% vs Average for Samples 1-8: 94.9%), but not able to achieve CCD values comparable to the average of Samples 1-8 (Comparative 1: 0.4 mA·cm⁻² vs Average for Samples 1-8: 0.925 mA·cm⁻²) or even come close to CCD value for Sample 2 (1.4 mA·cm⁻²). The sintering mechanism of LLZO is a gas-liquid-solid process. Li₂O gas condenses into a liquid phase on the surface of the LLZO particles. Dissolution-precipitation promotes material transport, resulting in grain growth and enhanced densification. Both the mother powder and LZO can provide a Li₂O atmosphere for LLZO sintering whereby LLZO obtains a Li₂O atmosphere from the outside and the inside, respectively.

Relative density of Samples 1-8, which comprise an LZO additive (either LZO-4 or LZO-4.5) increases when firing at 1190° C., suggesting that LZO may help to densify garnet and lower the sintering temperature. As stated above, release of Li₂O by LZO promotes LLZO densification. As stated in Example 3 describing the preparation of Li-garnet composite ceramic electrolytes of Samples 1-8, mother powder was not used in the sintering process for Samples 1-8. The relative densities of the LLZO-LZO composites of Samples 1-8 also indicate that inclusion of mother powder is not a critical component of the sintering process since decomposition of LZO will provide a Li₂O sintering atmosphere. Thus, because of this Li₂O sintering atmosphere and lowered sintering temperature, the sintering process is simplified and cheaper. Further, the lithium-rich additives and their decomposition products are distributed at the LLZO grain boundary, which enhances bonding at the LLZO grain boundary and blocks formation of lithium dendrite growth.

All of Samples 1-8 have high ionic conductivity exceeding at least 0.6 mS·cm⁻¹, comparable to that in Comparative Sample 1. Comparative Sample 2 has very low conductivity (0.0123 mS·cm⁻¹) since it was not well sintered. Addition of LZO also leads to an increase in CCD of the Li-garnet. CCD reaches 1.4 mA·cm⁻² when mass ratio of LZO and LLZO is 4/100 and the composite is fired in an MgO crucible. As mentioned above, sintering of LLZO depends on the Li₂O atmosphere. While MgO and Pt crucibles are relatively stable with Li₂O, Al₂O₃ and ZrO₂ crucibles easily react with Li₂O to form LiₓAlO_{y} and LiₓZrO_{y}, respectively, at high temperatures, which makes LLZO difficult to sinter and densify. Thus, Al₂O₃ and ZrO₂ crucibles often require repeated sintering and may be used for LLZO sintering only after forming a passivation layer.

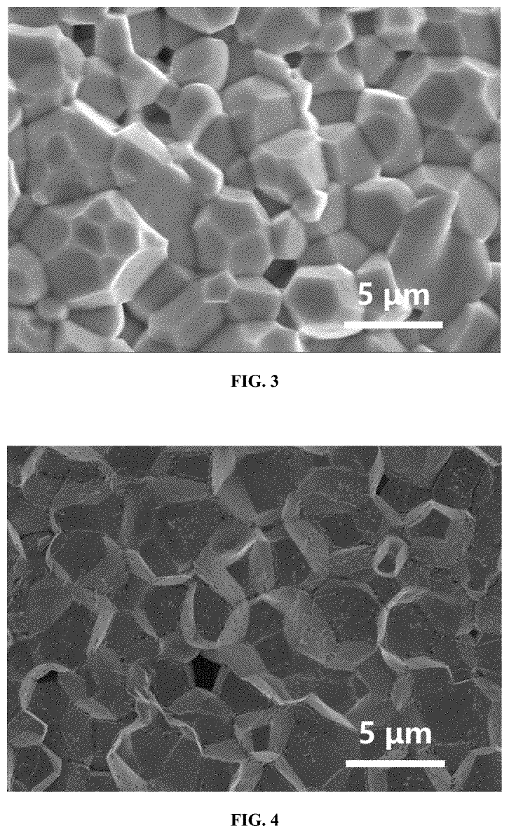

FIGS. 3 and 4 illustrate cross-sectional SEM image of Comparative Sample 1 and Sample 7, respectively, according to some embodiments. As observed in FIG. 3, no obvious impurities are seen in the grain boundary of Comparative Sample 1. When LZO is added, as in Sample 7 (FIG. 4), some particles exist in the grain boundaries or grain surface. Examination by EDS reveals that zirconium and oxygen are the primary components of the particles, with almost no tantalum being detected. Accordingly, the particles are identified as Li₆Zr₂O₇ or Li₈ZrO₆ (with their decomposition products being Li₂ZrO₃, Li₂O, or combinations thereof). This confirms the XRD patterns of LZO-4.5 in FIG. 1 and Sample 7 in FIG. 2. For each of Samples 1-8, LZO exists as the minor or second phase in the grain boundary of the composite garnet and helps to block the Li dendrite growth route, leading to an increase of CCD.

Thus, as presented herein, this disclosure relates to improved lithium-garnet composite ceramic electrolytes for enhanced Li anode/garnet electrolyte interfaces in solid-state lithium metal battery applications. Advantages of the formed Li-garnet composite ceramic electrolytes include: (1) a higher critical current density (CCD), since lithium-rich additives and their decomposition products are distributed at the LLZO grain boundary, which enhances bonding at the LLZO grain boundary and blocks lithium dendrite growth; and (2) a simplified and cheaper sintering process, because (a) Li-garnet is densified at a lower sintering temperature with the addition of LZO powder; and (b) no mother powder is added during ceramic sintering since lithium-rich additive (LiₓZrO_{(x+4)/2} (2≤x≤10); LZO) is able to provide a Li₂O sintering atmosphere.

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. A sintered composite ceramic, comprising:
a lithium-garnet major phase; and
a lithium-rich minor phase,
wherein the lithium-rich minor phase comprises LiₓZrO_{(x+4)/2}, with 2≤x≤10.

2. The sintered composite ceramic of claim 1, wherein the lithium-garnet major phase comprises at least one of:
(i) Li₇₋₃ₐLa₃Zr₂LₐO₁₂, with L=Al, Ga or Fe and 0<a<0.33;
(ii) Li₇La_{3-b}Zr₂M_{b}O₁₂, with M=Bi or Y and 0<b<1;
(iii) Li_{7-c}La₃(Zr_{2-c},N_{c})O₁₂, with N=In, Si, Ge, Sn, V, W, Te, Nb, or Ta and 0<c<1, or a combination thereof.

3. The sintered composite ceramic of claim 1, wherein a mass ratio of lithium-garnet major phase to lithium-rich minor phase is in a range of 100:1 to 100:12.

4. The sintered composite ceramic of claim 1, wherein a ratio of lithium-to-zirconium in the lithium-rich minor phase is in a range of 4 to 5.

5. The sintered composite ceramic of claim 1, wherein the ceramic has a relative density of at least 90% of a theoretical maximum density of the ceramic.

6. The sintered composite ceramic of claim 1, wherein the ceramic has an ionic conductivity of at least 0.6 mS·cm⁻¹.

7. The sintered composite ceramic of claim 1, wherein the ceramic has a critical current density (CCD) of at least 1.0 mA·cm⁻².

8. The sintered composite ceramic of claim 7, wherein the ceramic has a critical current density (CCD) of at least 1.4 mA·cm⁻².

9. A sintered composite ceramic, comprising:
a lithium-garnet major phase; and
a lithium-rich minor phase,
wherein the lithium-rich minor phase comprises at least one of: Li₆Zr₂O₇, Li₈ZrO₆, or a combination thereof.

10. The sintered composite ceramic of claim 9, wherein the lithium-garnet major phase comprises at least one of:
(i) Li₇₋₃ₐLa₃Zr₂LₐO₁₂, with L=Al, Ga or Fe and 0<a<0.33;
(ii) Li₇La_{3-b}Zr₂M_{b}O₁₂, with M=Bi or Y and 0<b<1;
(iii) Li_{7-c}La₃(Zr_{2-c},N_{c})O₁₂, with N=In, Si, Ge, Sn, V, W, Te, Nb, or Ta and 0<c<1, or a combination thereof.

11. The sintered composite ceramic of claim 9, wherein a mass ratio of lithium-garnet major phase to lithium-rich minor phase is in a range of 100:1 to 100:12.

12. The sintered composite ceramic of claim 9, wherein a ratio of lithium-to-zirconium in the lithium-rich minor phase is in a range of 4 to 5.

13. The sintered composite ceramic of claim 9, wherein the lithium-rich minor phase comprises one of:
(i) Li₆Zr₂O₇; or
(ii) Li₆Zr₂O₇ and Li₈ZrO₆.

14. A battery, comprising:
at least one lithium electrode; and
an electrolyte in contact with the at least one lithium electrode,
wherein the electrolyte is a lithium-garnet composite electrolyte comprising the sintered composite ceramic of claim 1.

15. A method of making the composite ceramic of claim 1, comprising:
a first mixing of inorganic source materials to form a mixture, including a lithium source compound and and at least one transition metal compound;
a first milling of the mixture to reduce the particle size of the precursors;
calcining the milled mixture to form a garnet oxide at from 800 to 1200° C.;
a second mixing of the milled and calcined garnet oxide with at least one minor phase additive to form a second mixture;
a second milling of the second mixture to reduce the particle size of constituents of the second mixture;
compacting the second milled second mixture into a green pellet; and
sintering the green pellet at a temperature ranging from 1000° C. to 1300° C.

16. The method of claim 15, wherein at least one of the lithium source compound or the minor phase additive is present in a stoichiometric excess.

17. The method of claim 15, wherein the minor phase additive comprises LiₓZrO_{(x+4)/2}, with 2≤x≤10.

18. The method of claim 15, wherein the minor phase additive comprises at least one of: Li₆Zr₂O₇, Li₈ZrO₆, or a combination thereof.

19. The method of claim 15, wherein a mass ratio of the milled and calcined garnet oxide to the at least one minor phase additive is in a range of 100:1 to 100:12.

20. The sintered composite ceramic of claim 15, wherein a ratio of lithium-to-zirconium in the at least one minor phase additive is in a range of 4 to 5.
